(19) United States
(12) Patent Application Publication
(10) Pub. No.: US 2018/0070418 A1
(43) Pub. Date: Mar. 8, 2018

(54) VOLTAGE-DEPENDENT OPERATION OF INDIVIDUAL LIGHT SOURCES

(71) Applicant: OSRAM GmbH, Munich (DE)

(72) Inventor: Martin Brueckel, Karlsruhe (DE)

(21) Appl. No.: 15/698,694

(22) Filed: Sep. 8, 2017

(30) Foreign Application Priority Data
Sep. 8, 2016 (DE) 10 2016 217 056.2

(51) Int. Cl. H05B 33/08

(52) U.S. Cl. CPC H05B 33/0827; H05B 33/0845; H05B 33/0812; H05B 33/083

(57) ABSTRACT

A method for operating a lighting device which has a plurality of light sources includes ascertaining a measure of a supply voltage, switching the light sources into one or more parallel strings. The light sources are in each case connected in series in each string, depending on the supply voltage. The method further includes automatically ascertaining a number of light sources in at least one of the strings. The number corresponds to the largest integer number which, multiplied by a prespecifiable forward voltage of each of the light sources, is less than the supply voltage. When the light sources are switched into the at least one string precisely the number of light sources are connected in series. A switch is connected in parallel with each of the light sources, and either a variable resistor or a variable resistor is connected in series with each string of light sources.

### CROSS-REFERENCE TO RELATED APPLICATION

This application claims priority to German Patent Application Serial No. 10 2016 217 056.2, which was filed Sep. 8, 2017, and is incorporated herein by reference in its entirety.

### TECHNICAL FIELD

Various embodiments relate generally to a method for operating a lighting device, and to a lighting device which has a plurality of light sources, wherein the light sources can be interconnected depending on an input voltage, and each light source can be individually switched and dimmed.

### BACKGROUND

Various embodiments relate to a method for operating a lighting device, which has a plurality of light sources, by measuring a supply voltage and switching the light sources into one or more parallel strings depending on the measured supply voltage. In this case, the light sources are in each case connected in series in each string. Various embodiments relate to a lighting device which has a plurality of light sources, in which lighting device a supply voltage is measured and the light sources are switched into one or more parallel strings depending on the measured supply voltage. In this case, the light sources are in each case connected in series in each string. Various embodiments also relate to a motor vehicle having a lighting device of this kind.

Lighting devices for motor vehicles usually have light emitting diodes LEDs or laser diodes and current drivers. There are various ways of realizing lighting devices of this kind. Firstly, a discrete design of diodes and driver modules in one or more subassemblies can be selected and secondly fully integrated circuits can also be selected. Furthermore, mixed solutions including discrete and fully integrated circuit elements are also possible.

Particular requirements are made of lighting devices, especially in the motor vehicle sector. For example, they should generally not only be cost-effective but also compact. However, in addition, they should also be robust and should cause as little electromagnetic interference as possible.

In the motor vehicle sector, it has to be possible to operate drivers of lighting devices from on-board electrical systems of motor vehicles. These typically fluctuate between 9 V and 16 V. The battery or on-board electrical system voltage can dip to a greater or lesser extent depending on the respectively active loads. The on-board electrical system voltage is particularly pronounced, for example when operating the ignition or the starter. A constant current or a current which is controlled depending on input variables has to be delivered at the output of the driver in each case.

Available drivers include, for example, switched DC/DC converters. These are generally relatively complex and have a housing and also corresponding cabling, which can take up a relatively large amount of installation space. On account of the clocked operation, EMC protection is also required, this additionally increasing the costs of the driver. However, one effect of said switched DC/DC converter is that the electrical losses are usually only low. They are, for example, 10% of the output power. During operation of two light-emitting diodes for example, which diodes have a forward voltage of 3.5 V and are supplied with a current of 1 A, the power loss is Pv=2×3.5 V×1 A×10%=0.7 W. On account of their low level of loss, the switching converters are used particularly for light sources with a high light current, for example a low beam and a high beam.

As an alternative, linear controllers or so-called rheostatic controllers (series resistor in series with an LED connected to a voltage source) are often used nowadays as a more cost-effective solution with less stringent requirements. They cause a relatively low level of electromagnetic interference. However, owing to their high level of power loss which is given by the product of output current and voltage drop, their field of application is currently limited. If the two LEDs mentioned above are operated from an on-board electrical system with an electrical system voltage of 13 V, the voltage 13 V−2×3.5 V=6 V is dropped across the driver. Accordingly, the power loss is 6 V×1 A=6 W. Nevertheless, it would be desirable to be able to use rheostatic and linear controllers of this kind, which are smaller, cheaper and cause less interference than switching converters, for lighting devices, particularly in the motor vehicle sector.

DE 10 2013 201 766 A1 discloses a lighting device including a plurality of semiconductor light sources and an apparatus for operating the semiconductor light sources. The apparatus has switching means by way of which the semiconductor light sources can be divided into groups for operation using the apparatus. The division is performed, in particular, depending on the on-board electrical system voltage.

### SUMMARY

A method for operating a lighting device which has a plurality of light sources includes ascertaining a measure of a supply voltage, switching the light sources into one or more parallel strings. The light sources are in each case connected in series in each string, depending on the supply voltage. The method further includes automatically ascertaining a number of light sources in at least one of the strings. The number corresponds to the largest integer number which, multiplied by a prespecifiable forward voltage of each of the light sources, is less than the supply voltage. When the light sources are switched into the at least one string precisely the number of light sources are connected in series. A switch is connected in parallel with each of the light sources, and either a variable resistor or a variable resistor is connected in series with each string of light sources.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic circuit diagram of a lighting device according to various embodiments;

FIG. 2 shows a flowchart of a method according to various embodiments for operating a lighting device; and

FIG. 3 shows a section of a schematic circuit diagram of a light-emitting diode driver of the lighting device, to which light-emitting diode driver a light-emitting diode is connected.

### DESCRIPTION

The following detailed description refers to the accompanying drawings that show, by way of illustration, specific details and embodiments in which the invention may be practiced.

It should be noted that the individual features of various embodiments can be realized both in the described combinations of features but also on their own or in other technically meaningful combinations.

Various embodiments operate, for example, a lighting device including a large number of light emitting diodes (LEDs) in a motor vehicle as far as possible without loss and with a low level of radiation. In various embodiments, for example, a dipped beam and/or high beam of the motor vehicle can be realized in this way. The LEDs represent all possible light sources, e.g. semiconductor light sources. The reference to a motor vehicle is also purely exemplary and the embodiments can also serve for other purposes.

It is now desirable to use a linear or resistance driver for the lighting device. These have a relatively simple design, specifically possibly only one resistor in series with the load or the light sources in the case of a resistance driver. The resistor can optionally be temperature-dependent (for example PTC or NTC).

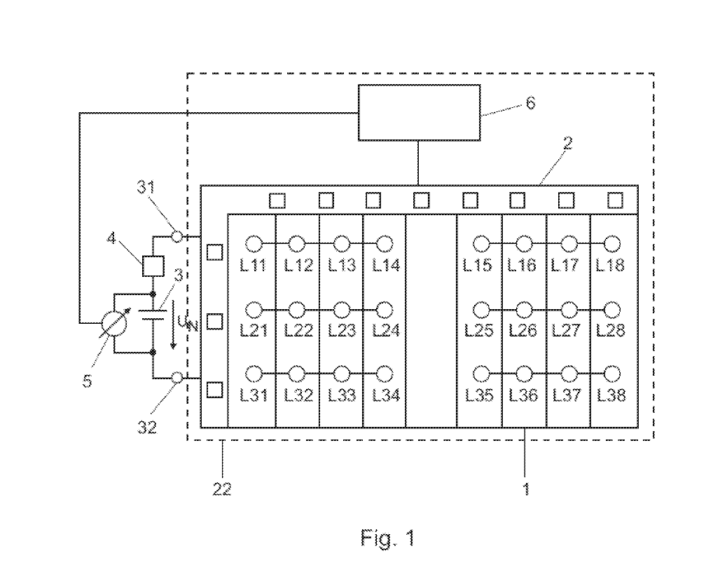

In a specific example, the lighting device has a matrix 1 of light sources or LEDs L11, L12, L13, . . . , L18; L21, L22, L23, . . . L28; L31, L32, L33, . . . , L38, as is illustrated in FIG. 1. Said light sources or LEDs are intended to be interconnected in various ways depending on a supply voltage UN which is delivered by an on-board electrical system for example. The interconnection is intended to be performed in such a way that the sum of the diodes which are connected in series is always equal to or just below the on-board electrical system voltage or supply voltage.

In the example of FIG. 1, the matrix 1 of LEDs is interconnected by a switching apparatus 2. Said switching apparatus is able to connect a plurality of the LEDs in series to form a string. Further LEDs are interconnected in groups to form a second, third string etc. In the example of FIG. 1, six strings, each with four LEDs, are formed. A first string is formed by the LEDs L11 to L14, a second string is formed by the LEDs L15 to L18, a third string is formed by the LEDs L21 to L24, a fourth string is formed by the LEDs L25 to L28, a fifth string is formed by the LEDs L31 to L34 and a sixth string is formed by the LEDs L35 to L38. As an alternative, other groups of in each case four LEDs can also be formed. For example, the LEDs L11, L21, L31 and L32 can also be connected to form a string or a group. The further LEDs can be further grouped as desired.

As distinct from the example of FIG. 1, strings with three LEDs, two LEDs, six LEDs, eight LEDs etc. can also be formed. In an extreme case, even a single string with 24 LEDs is formed or 24 “strings” each with one LED are formed. In the selected example of 24 LEDs, the following groupings are possible (number of strings×number of LEDs):

24×1

12×2

8×3

6×4

4×6

3×8

2×12

1×24

Instead of the number 24 in the above example, any desired number can be selected for the number of LEDs in principle. However, a number of LEDs which allows various string formations without leftovers may be provided, wherein the difference between the string lengths is in each case only 1 at least in an exemplary region. As shown in the above table, strings with 1, 2, 3 and 4 LEDs can be formed in the case of 24 LEDs, wherein all of the LEDs are always used and all of the strings are of equal length. The text which follows generally reveals how the strings are intended to be formed. The following processes can be followed in the process:

a) The forward voltage of each LED, laser diode or other light source in the lighting device can be limited to a range of from U_LED_min to U_LED_max by their specification or known value range. In the most complicated case, the specific voltage is measured and in the simplest case it is prespecified or is defined at a specific value, for example U_LED=3.5 V.

b) The on-board electrical system voltage or supply voltage is in a range of from U_ON-BOARD min to U_ON-BOARD_max. On account of the often severe fluctuations, the current on-board electrical system voltage should be measured.

c) The maximum number of LEDs in series is defined at N_SERIES_max=U_ON-BOARD_max/U_LED.

d) The minimum number of LEDs in series is defined at N_SERIES_min=U_ON-BOARD min/U_LED.

e) The specific number of LEDs connected in series at a particular moment is defined at N_CURRENT=largest integer value which is smaller than U_ON-BOARD/U_LED.

f) The number of LEDs in the lighting device may be selected in accordance with N_LED_TOTAL=N_SERIES_min×(N_SERIES_min+1)×(N_SERIES_min+2)× . . . ×N_SERIES_max. If N_SERIES_min=1, N_LED_TOTAL=N_SERIES_max!, that is to say the factorial of the maximum number of light sources in series. Otherwise, N_LED_TOTAL=N_SERIES_max!/(N_SERIES_min−1)!

In FIG. 1, the on-board electrical system is symbolized by a battery 3 which delivers the on-board electrical system voltage UN. In an embodiment, the LEDs of the lighting device are operated in a simple manner by means of a resistance driver, that is to say a series resistor 4 (as an alternative, a linear driver could also be used here). The respective number of LEDs are in each case connected in series in a plurality of strings by the switching apparatus 2, and the strings are connected in parallel with one another. The parallel strings are supplied with current by the resistance driver.

In order to connect the LEDs in an intelligent manner to form strings, the supply voltage or on-board electrical system voltage is measured by a measuring device 5. The corresponding measurement signal is supplied to a control apparatus 6 which automatically ascertains the number of light sources or LEDs in at least one of the strings, e.g. in all of the strings, wherein the number corresponds to the largest integer number which, multiplied by a prespecifiable forward voltage (for example 3.5 V) of each of the light sources, is less than the measured supply voltage.

A specific example is illustrated in the text which follows. The forward voltage of an LED is defined at U_LED=3.5 V. The two limits U_ON-BOARD_min=9 V and U_ON-BOARD_max=16 V are defined for the supply voltage range. Therefore, at an on-board electrical system voltage of 9 V, only two LEDs can be connected in series, and therefore N_SERIES_min=2. The forward voltage of the two LEDs is then 7 V and is below 9 V. At the maximum on-board voltage of 16 V, four LEDs can be connected in series, which then lead to a total forward voltage of 14 V, which corresponds to the largest integer value below the maximum on-board voltage of 16 V. Therefore, a total number of LEDs N_LED_TOTAL=2×3×4=24 would therefore result in accordance with point f) above. This total number would also remain the same if the on-board electrical system voltage were to drop below 7 V and therefore there is only one single LED in a string.

Case 1:

The current on-board electrical system voltage is U_ON-BOARD=13.5 V. For this voltage, three LEDs can be connected in series, and therefore N_CURRENT=3. As a result, the sum of all of the U_LEDs is precisely 10.5 V. This is just below the current on-board electrical system voltage of 13.5 V. In a linear driver, given an LED current I_LED, there is a power loss of: dU× I_LED=3.0 V× I_LED.

Case 2:

If the on-board electrical system voltage is 16 V, N_CURRENT=4 for each string. As a result, the sum of all of the U_LEDs is precisely 14 V, this likewise being just below the current on-board electrical system voltage of 16 V. In a linear driver, there is then a power loss of: dU×I_LED=2.0 V×I_LED.

Case 3:

If the on-board electrical system voltage U_ON-BOARD is 9 V, N_CURRENT would=2 for the number of LEDs in one string. As a result, the sum of all of the U_LEDs is precisely 7 V, this again being just below the current on-board electrical system voltage of 9 V. In a linear driver, there is a power loss of: dU×I_LED=2.0 V×I_LED.

The current through an LED I_LED is typically =1 A. However, it can also have values such as, for example, 2.0 A, 0.5 A, 0.1 A or the like. In the case of I_LED=1 A, the losses in the above three cases would be 2 W and, respectively, 3 W.

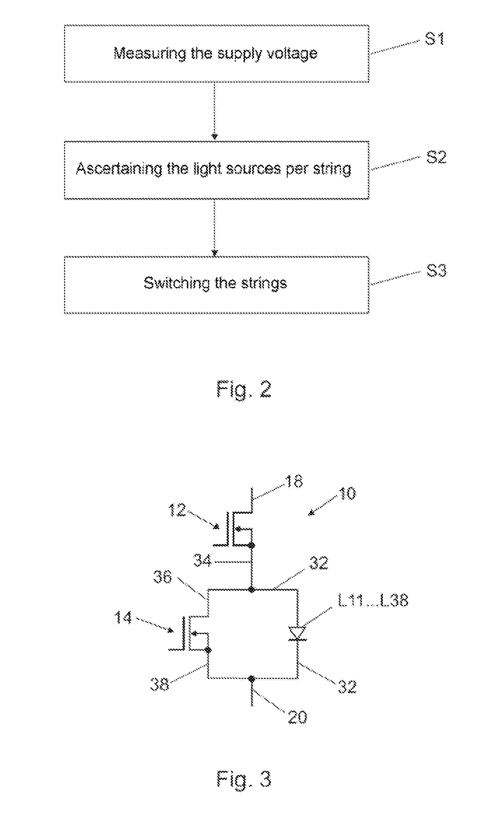

FIG. 2 schematically illustrates the method sequence for switching the light sources. In S1, the supply voltage (for example the on-board electrical system voltage) of the lighting device is measured. Subsequently, in S2, the number of light sources in at least one of the strings, e.g. in all of the strings, is automatically ascertained. In this case, the number of light sources per string should be as equal as possible. It holds true for the (respectively) ascertained numbers that the number corresponds to the largest integer number which, multiplied by a prespecifiable forward voltage of each of the light sources, is smaller than the measured supply voltage. Then, in S3, precisely the ascertained number of light sources are connected in series in a respective string.

Defining the ideal total number in accordance with point f) above allows a lighting device to be realized in which all light sources (LEDs, laser diodes and the like) can be consistently driven at all voltage values of the on-board electrical system or of the supply voltage. In various embodiments, the driving can be performed, by way of example, by a linear or resistance driver in such a way that the power loss in the driver is minimized. It is therefore possible to use linear or resistance drivers, which are simple, have a low level of interference and are robust, given relatively high LED currents where previously only switching converters could be used.

This solution allows a very compact LED lighting device, which can be constructed in a single integrated housing in an extreme case, for a dipped beam and a high beam. The saving potential can include a major portion of the costs, the installation space and the complexity of switching converter solutions.

FIG. 3 shows a schematic circuit diagram of a section 10 of the switching apparatus 2 as a light source driver for a light-emitting diode L11 to L38, which is connected to the switching apparatus 2, of a second embodiment. The section 10 therefore corresponds to a light-emitting diode L11 to L38 in the preceding embodiments. The connections 18 and 20 of the section 10 therefore correspond to an anode and a cathode of one of the light-emitting diodes L11 to L38. Therefore, instead of a light-emitting diode L11 to L38, a circuit according to the section 10 is connected to the respective light-emitting diode L11 to L38. Therefore, in FIG. 3, the light-emitting diode L11 to L38 is a light-emitting diode from amongst a plurality of light-emitting diodes L11 to L38 which are combined to form the light-emitting diode matrix 1 in the switching apparatus 2 of FIG. 1.

The light-emitting device 22 is a constituent part of a motor vehicle headlamp, not illustrated any further, and is supplied with electrical energy from an on-board electrical system of the motor vehicle by means of the battery 3. In the present case, the electrical voltage through the battery 3 is an electrical DC voltage UN which is approximately 12 V in the present case. The figure does not illustrate that the switching apparatus 2 further has a communications interface via which the switching apparatus 2 is likewise connected to a superordinate motor vehicle controller. As a result, it is possible to not only switch on and switch off the motor vehicle headlamp, but furthermore also to provide a prespecifiable lighting pattern using the light-emitting diode matrix 24. This can serve to generate a prespecified lighting setting in the illuminable region using the motor vehicle headlamp.

FIG. 3 shows a section 10 of the switching apparatus 2 with one individual light-emitting diode from amongst the light-emitting diodes L11 to L38. In the present case, it is provided that a first transistor 12, which is in the form of a MOSFET (Metal Oxide Semiconductor Field Effect Transistor) in the present case, is connected by way of a drain connection 18 to a positive potential of the supplied electrical DC voltage by means of the switching apparatus 2. A drain connection 36 of a further MOSFET 14 is connected to a source connection 34 of the MOSFET 12. A source connection 38 of the MOSFET 14 forms a connection 20. An anode of one of the light-emitting diodes L11 to L38 is further connected to the source connection 34 of the MOSFET 12. A cathode of the light-emitting diodes L11 to L38 is connected to the connection 20, so that the light-emitting diodes L11 to L38 are each connected in parallel with the drain-source path of the MOSFET 14. The operation of the MOSFETs 12, 14 is accordingly controlled by a control unit, not illustrated, of the switching apparatus 2 via gate connections, not designated further, of the MOSFETs 12, 14. The control unit is further connected to the communications interface.

The MOSFET 12 is adjusted such that it provides a suitable direct current, which is set to be constant in the present case, for the intended operation of the light-emitting diodes L11 to L38, that is to say for emitting light through the light-emitting diodes L11 to L38. The MOSFET 12 therefore operates as a current source. Therefore, various embodiments do not have a series resistor 4 since each of the light-emitting diodes L11 to L38 has its own current source in the MOSFET 12. The resistance value of the series resistor 4 is accordingly 0 ohm in various embodiments.

The MOSFET 14 now serves to short-circuit the light-emitting diodes L11 to L38 depending on the switching state. To this end, the MOSFET 14 is operated in a switched mode. If the MOSFET 14 short-circuits one of the light-emitting diodes L11 to L38, the direct current provided by the MOSFET 12 flows away through the MOSFET 14 to the connection 20. Substantially no current flows through the light-emitting diode in question, and therefore no light is emitted. If, however, the MOSFET 14 is switched off, the current provided by the MOSFET 12 flows through the light-emitting diode in question to the connection 20, and therefore the light-emitting diode emits light in the intended manner. The MOSFET 14 which is connected in parallel with each light-emitting diode L11 to L38 and can either switch on or switch off the respective light-emitting diode may be operated with pulse-width modulation in order to dim the respective light-emitting diode by switching on and switching off said light-emitting diode in quick succession. However, pure switch-on and switch-off operation can likewise be performed.

In various embodiments, further parallel circuits each including one MOSFET 14 and one light-emitting diode L11 to L38 can be provided at the connection 20 in order to be able to utilize the DC voltage provided by the motor vehicle-side on-board electrical system in as optimum a manner as possible. Therefore, each of the six strings of FIG. 1 can be provided with one MOSFET 12 in each case, said MOSFET serving as a current source for the respective string. As a result, the connection 20 is indirectly or directly connected to the negative potential 32 of the DC voltage of the on-board electrical system. In various embodiments, each of the light-emitting diodes L11 to L38 has its own MOSFET 12 as current source. This is expedient particularly when, given a very low on-board electrical system voltage, for example when starting the automobile, all of the light-emitting diodes L11 to L38 are connected in parallel, in order to create light output by the lighting apparatus 22 even at this low on-board electrical system voltage. In switching states in which two or more of the light-emitting diodes are connected in series, the respective MOSFETs 12 of the light-emitting diodes in question are to be jointly driven to a current level at which the respective string is intended to be operated.

Furthermore, in various embodiments, this circuit has proven effects in as much as no voltage jumps, which can lead to undesired electromagnetic interference, occur on the on-board electrical system side when switching individual light-emitting diodes L11 to L38 or else all of the light-emitting diodes L11 to L38 because, on account of this circuit structure, the current can remain substantially constant. Furthermore, this circuit, owing to setting of the current by means of the MOSFET 12, allows all of the light-emitting diodes L11 to L38, which are connected to said MOSFET, to be operated substantially in the same operating state in the switched-on operating state. In this respect, the power converted by this branch of the switching apparatus 2 is substantially constant and independent of whether the light-emitting diodes L11 to L38 emit light or not. In the present case, the switching apparatus 2 contains an ASIC. Each LED can be individually switched on and switched off by the MOSFETs 14 which are connected in parallel. Since the MOSFETs 14 can also be operated by pulse-width modulation, they can likewise be dimmed and the lighting apparatus 22 can be adjusted to different conditions in this way.

List of Reference Symbols

| L11 to L14 | LEDs of a first string |
|---|---|
| L15 to L18 | LEDs of a second string |
| L21 to L24 | LEDs of a third string |
| L25 to L28 | LEDs of a fourth string |
| L31 to L34 | LEDs of a fifth string |
| L35 to L38 | LEDs of a sixth string |
| 1 | Light-emitting diode matrix |
| 3 | Battery |
| 4 | Series resistor |
| 5 | Measuring device |
| 6 | Control apparatus |
| 10 | Section |
| 12 | MOSFET |
| 14 | MOSFET |
| 16 | Light-emitting diode from amongst the LEDs L11 to L38 |
| 18 | Drain connection |
| 20 | Connection |
| 22 | Light-emitting device |
| 34 | Source connection |
| 36 | Drain connection |
| 38 | Source connection |

Various embodiments operate a lighting device including a plurality of light sources with as low a level of loss as possible and, in the process, to acquire a maximum degree of flexibility in respect of the permitted input voltage and the switching states of the light-emitting diodes.

Various embodiments provide a method for operating a lighting device, which has a plurality of light sources, by ascertaining a measure of a supply voltage and switching the light sources into one or more parallel strings, wherein the light sources are in each case connected in series in each string, depending on the measure of the supply voltage, automatically ascertaining a number of light sources in at least one of the strings, wherein the number corresponds to the largest integer number which, multiplied by a prespecifiable forward voltage of each of the light sources, is less than the measure of the supply voltage, and wherein when the light sources are switched into the at least one string precisely the ascertained number of light sources are connected in series, wherein a switch is connected in parallel with each of the light sources, and either a variable resistor is connected in series with each of the light sources or a variable resistor is connected in series with each string of light sources.

Furthermore, various embodiments provide a lighting device including a plurality of light sources, an ascertaining device for ascertaining a measure of a supply voltage, and a switching apparatus for switching the light sources into one or more parallel strings, wherein the light sources are in each case connected in series in each string, depending on the ascertained measure of the supply voltage, and also including a control apparatus for automatically ascertaining a number of light sources in at least one of the strings, wherein the number corresponds to the largest integer number which, multiplied by a prespecifiable forward voltage of each of the light sources, is less than the ascertained measure of the supply voltage, wherein the switching apparatus can be driven by the control apparatus in such a way that, in the at least one string, precisely the ascertained number of light sources are connected in series, wherein a switch is connected in parallel with each of the light sources, and either a variable resistor is connected in series with each of the light sources or a variable resistor is connected in series with each string of light sources. In various embodiments, at least one of the strings is configured such that the number of its light sources corresponds to the largest integer value which is less than, for example, the quotient of the current on-board electrical system voltage or supply voltage and the prespecifiable forward voltage of a light source. This number of light sources can be ascertained purely by calculation or on the basis of measurements during operation or during initial calibration. Therefore, the forward voltage of the entire string is equal to or slightly below the supply voltage. If the string is now operated with a linear or resistance driver, only minimal losses occur owing to the minimal difference between forward voltage and supply voltage.

Ascertaining a measure of the supply voltage can involve measuring the supply voltage. As an alternative, a measure or representative of the supply voltage can also be represented, for example, by a state of a circuit. For example, a circuit with a voltage reference/voltage references, for example by means of a Zener diodes or other diodes, could be used, which circuit assumes certain switching states, which can be used as a control variable, depending on the supply voltage. In this case, the supply voltage does not have to be explicitly measured.

The forward voltage of the individual light sources or a plurality thereof can be prespecified or measured. For example, said forward voltage can be predefined for a specific operating point for simplifying automatic ascertaining of the number of light sources in a string. However, a further optimization in respect of the reduction in losses can possibly be achieved by the actual forward voltage of one, a plurality of or all of the light sources or of a specific string being measured and dynamic matching to the supply voltage being possible in this way.

All of the parallel strings preferably have the same number of light sources in series. As a result, it is possible for a single driver to be used for all of the strings.

In a refinement, a minimum voltage value and a maximum voltage value are prespecified for the supply voltage. A minimum number of light sources is then ascertained in at least one of the strings to the effect that the minimum number corresponds to the largest integer number which, multiplied by the prespecifiable forward voltage of each of the light sources, is less than the minimum voltage value. Similarly, a maximum number of light sources is ascertained in at least one of the strings to the effect that the maximum number corresponds to the largest integer number which, multiplied by the prespecifiable forward voltage of each of the light sources, is less than the maximum voltage value. In this case, an integer number between the minimum number and the maximum number is selected as the number of light sources. By virtue of a minimum number and a maximum number being defined in this way, it is easily possible to select an integer number of light sources between said numbers. This can be done, for example, using a lookup table in which the measured supply voltage is associated with a number of light sources.

In a refinement, the total number of light sources of the lighting device corresponds to the quotient of (maximum number) factorial and (minimum number −1) factorial. In this way, strings of the same length can always be formed, and it is not necessary for one or a few other light sources to be driven separately.

As has already been indicated above, the minimum difference between the forward voltage of an entire string and the supply voltage allows the use of linear drivers and resistance drivers since the losses are minimized. This once again results in advantages in respect of installation space, costs and EMC.

In particular, the lighting device can have a single linear driver or resistance driver for supplying electrical power to all of the light sources. This leads to further effects in respect of installation space and costs.

As an alternative, the lighting device can have a separate linear driver or resistance driver for supplying electrical power to the light sources for each string. In this way, it is also possible to subdivide any desired number of light sources into individual strings and still operate said light sources in a manner with a relative reduction in losses. In various embodiments, each string has a variable resistor which operates as a linear driver. The variable resistor is therefore operated as a current source in order to ensure a predetermined current through the light sources.

In various embodiments, each light source has a variable resistor connected in series with it, said variable resistor operating as a linear driver, that is to say being connected as a current source. If a plurality of light sources are connected in series on account of the input voltage, the respective variable resistors are jointly driven in such a way that a predetermined current flows through the string including light sources which are connected in series.

In various embodiments, the switch is a transistor which is operated using a wiring diagram or by pulse-width modulation. As a result, each of the light sources can be individually switched on and switched off or can be dimmed by pulse-width modulation. When the light sources are arranged in a matrix which serves as main beam or dipped beam of a headlamp, each of the pixels of the matrix can be switched or dimmed. This may be provided e.g. in the case of cornering light or in the case of matrix headlamps which dazzle oncoming traffic. In this case, dazzling of other road users can be precluded by turning off individual pixels, or else reduced by dimming said pixels.

The light sources may be light-emitting diodes, laser diodes or modules thereof. Here, a module is understood to mean a fixed assembly including one or more light-emitting diodes and/or laser diodes.

In various embodiments, a motor vehicle is equipped with at least one of the lighting devices described above. Therefore, various effects of the solution according to various embodiments in respect of power loss, installation space, robustness and EMC compatibility in motor vehicles come into effect where these advantages are particularly significant. In this case, the use is not limited to motor vehicles, but rather is expedient anywhere that supply voltages fluctuate, that is to say particularly in mobile devices in which the supply voltage often fluctuates extremely severely.

Further developments and refinements of the method according to various embodiments and of the lighting device according to various embodiments can be gathered from further dependent claims and from the following description.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for operating a lighting device which has a plurality of light sources, the method comprising:
ascertaining a measure of a supply voltage;
switching the light sources into one or more parallel strings, wherein the light sources are in each case connected in series in each string, depending on the measure of the supply voltage;
automatically ascertaining a number of light sources in at least one of the strings;
wherein the number corresponds to the largest integer number which, multiplied by a prespecifiable forward voltage of each of the light sources, is less than the measure of the supply voltage;
wherein, when the light sources are switched into the at least one string precisely the ascertained number of light sources are connected in series;
wherein a switch is connected in parallel with each of the light sources, and either a variable resistor is connected in series with each of the light sources or a variable resistor is connected in series with each string of light sources.

2. The method of claim 1,
wherein the forward voltage is prespecified or measured at one or more of the light sources.

3. The method of claim 1,
wherein all of the parallel strings contain the same number of light sources in series.

4. The method of claim 1,
wherein a minimum voltage value and a maximum voltage value are prespecified for the supply voltage, a minimum number of light sources is ascertained in at least one of the strings to the effect that the minimum number corresponds to the largest integer number which, multiplied by the prespecifiable forward voltage of each of the light sources, is less than the minimum voltage value, and a maximum number of light sources is ascertained in at least one of the strings to the effect that the maximum number corresponds to the largest integer number which, multiplied by the prespecifiable forward voltage of each of the light sources, is less than the maximum voltage value; and
wherein an integer number between the minimum number and the maximum number is selected as the number of light sources.

5. The method of claim 4,
wherein the total number of light sources of the lighting device corresponds to the quotient of (maximum number) factorial and (minimum number −1) factorial.

6. The method of claim 1,
wherein the variable resistor is a transistor which is operated as a current source or as a linear driver.

7. The method of claim 1,
wherein the switch is a transistor which is operated using a wiring diagram or by pulse-width modulation.

8. A lighting device, comprising:
a plurality of light sources;
an ascertaining device for ascertaining a measure of a supply voltage;
a switching apparatus for switching the light sources into one or more parallel strings, wherein the light sources are in each case connected in series in each string, depending on the ascertained measure of the supply voltage;
a control apparatus for automatically ascertaining a number of light sources in at least one of the strings, wherein the number corresponds to the largest integer number which, multiplied by a prespecifiable forward voltage of each of the light sources, is less than the ascertained measure of the supply voltage;
wherein the switching apparatus can be driven by the control apparatus in such a way that, in the at least one string, precisely the ascertained number of light sources are connected in series;
wherein a switch is connected in parallel with each of the light sources, and either a variable resistor is connected in series with each of the light sources or a variable resistor is connected in series with each string of light sources.

9. The lighting device of claim 8,
wherein the light sources are light-emitting diodes or laser diodes or modules thereof.

10. The lighting device of claim 8,
wherein the variable resistor is a transistor which is operated as a current source.

11. The lighting device of claim 8,
wherein the switch is a transistor which is operated using a wiring diagram or by pulse-width modulation.

12. A motor vehicle, comprising:
a lighting device, comprising:
a plurality of light sources;
an ascertaining device for ascertaining a measure of a supply voltage;
a switching apparatus for switching the light sources into one or more parallel strings, wherein the light sources are in each case connected in series in each string, depending on the ascertained measure of the supply voltage;
a control apparatus for automatically ascertaining a number of light sources in at least one of the strings, wherein the number corresponds to the largest integer number which, multiplied by a prespecifiable forward voltage of each of the light sources, is less than the ascertained measure of the supply voltage;
wherein the switching apparatus can be driven by the control apparatus in such a way that, in the at least one string, precisely the ascertained number of light sources are connected in series;
wherein a switch is connected in parallel with each of the light sources, and either a variable resistor is connected in series with each of the light sources or a variable resistor is connected in series with each string of light sources.

13. The motor vehicle of claim 12,
wherein the light sources are light-emitting diodes or laser diodes or modules thereof.

14. The motor vehicle of claim 12,
wherein the variable resistor is a transistor which is operated as a current source.

15. The motor vehicle of claim 12,
wherein the switch is a transistor which is operated using a wiring diagram or by pulse-width modulation.
